(19) United States
(12) Patent Application Publication
(10) Pub. No.: US 2005/0252225 A1
(43) Pub. Date: Nov. 17, 2005

(54) Compressor - heat exchanger combination for vehicle air conditioner

(76) Inventor: Frank Vetter, Neuhausen (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/129,929

(22) Filed: May 16, 2005

(30) Foreign Application Priority Data
May 15, 2004 (DE) DE 10 2004 024 25

(51) Int. Cl. F25B 41/00; F25B 49/00; F25B 27/00; B60H 1/32

(52) U.S. Cl. 62/238.6; 62/323.1; 62/239

(57) ABSTRACT

A compressor and heat exchanger for a refrigerant loop of a vehicle air conditioner having at least one gas cooler/condenser, an evaporator and expansion valve, and a refrigerant which is subjected to heat exchange with coolant of the vehicle engine in at least one location of the refrigerant loop. The compressor is in heat exchange relationship with at least one refrigerant/coolant heat exchanger with at least one flow channel for the refrigerant and at least one flow channel for the coolant. There is at least one refrigerant inlet, and at least one refrigerant outlet on the high pressure side, wherein the refrigerant inlet and outlet are arranged in a single connection element. The heat exchanger is directly adjacent to the connection element, and at least one flow channel for coolant is in heat-conducting contact with the connection element.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention is directed toward precooling refrigerant, and particularly toward precooling refrigerant in the loop of a vehicle air conditioner.

### BACKGROUND OF THE INVENTION AND TECHNICAL PROBLEMS POSED BY THE PRIOR ART

Vehicle air conditioner refrigerant loops operating, for example, with CO₂ as the refrigerant, are known in which at least one gas cooler/condenser, an evaporator, an expansion valve and a compressor are included, and with the refrigerant in heat exchange with the coolant of the vehicle engine in at least one site of the refrigerant loop. In such loops, the working pressures on the high pressure side are relatively high (e.g., in the range of up to 150 bar or more), as are the temperatures without precooling of the refrigerant (e.g., in the range up to 170° C.). These pressures and temperatures cause extreme loads on the involved materials, and can significantly enhance wear and otherwise decrease their useful life.

EP 1 281 145 A1 proposes to conduct precooling of the refrigerant by the arrangement of the gas cooler in an air cooled heat exchanger arrangement. The feed line of the gas cooler is arranged either in contact with the heat exchanger tubes of the coolant cooler or a heat exchanger is situated in the equalization vessel provided in the cooling loop or also in one of the collecting tanks of the coolant cooler in order to achieve precooling of the refrigerant. EP 1 281 145 A1 also teaches that these individual expedients can also be combined in order to further optimize precooling. However, the attainable degree of precooling with the known arrangements can be unduly limited for certain applications.

EP 1 338 449 A1 also teaches an arrangement whereby the CO₂ is directly cooled on the high pressure side (i.e., behind the compressor by means of the engine coolant), with the described possibility of precooling used both for air conditioner operation and for the hot gas cycle. However, this arrangement requires that an additional heat exchanger be incorporated, thereby undesirably increasing the costs of the entire system.

EP 1 130 261 A2 and in EP 1 130 260 A2 teach indirectly cooling of the refrigerant using the compressor oil. The compressor oil is separated from CO₂ in an external separator so that the compressor oil is easily cooled, with the compressor and the CO₂ somewhat cooled in this manner. However, this is often not sufficient to reduce the high loads on the materials of the compressor in the air conditioner from the high temperatures that develop during compression of CO₂.

The present invention is directed toward overcoming one or more of the problems set forth above.

### SUMMARY OF THE INVENTION

In one aspect of the present invention, a compressor and heat exchanger are provided for a refrigerant loop of a vehicle air conditioner having at least one gas cooler/condenser, an evaporator and expansion valve, and a refrigerant which is subjected to heat exchange with coolant of the vehicle engine in at least one location of the refrigerant loop. The compressor is in heat exchange relationship with at least one refrigerant/coolant heat exchanger with at least one flow channel for the refrigerant and at least one flow channel for the coolant.

In one form of this aspect of the present invention, the refrigerant is CO₂.

In another form of this aspect of the present invention, the refrigerant flows in a selected direction and the heat exchanger, when viewed in the direction of refrigerant flow, is behind the compressor to cool the refrigerant on the high pressure side.

In still another form of this aspect of the present invention, there is at least one refrigerant inlet, and at least one refrigerant outlet on the high pressure side, wherein the refrigerant inlet and outlet are arranged in a single connection element. In a further form, the at least one refrigerant/coolant heat exchanger is directly adjacent to the connection element, and at least one flow channel for coolant is in heat-conducting contact with the connection element.

In yet another form of this aspect of the present invention, a separator is integrated in the compressor and adapted to remove compressor oil from the refrigerant, and a return is provided for the separated compressor oil.

In still another form of this aspect of the present invention, the heat exchanger exchanges heat between three media, and in a further form the media are coolant, CO₂, and compressor oil.

In yet another form of this aspect of the present invention, a second heat exchanger is in heat-conducting connection with the compressor, with the second heat exchanger tempering compressor oil by means of a coolant.

In still another form of this aspect of the invention, the shape of the heat exchanger is adapted to the shape of the compressor.

In another form of this aspect of the present invention, the refrigerant loop of the air conditioner consists essentially of a selected one of (a) only one cooling loop and (b) a cooling loop and a heating loop.

In another aspect of the present invention, an operating method is provided for an air conditioner with a refrigerant in a refrigerant loop having a cooling loop and a hot gas loop, with the refrigerant being subjected to heat exchange with the coolant of the vehicle engine in a heat exchanger in at least one location of the refrigerant loop. In accordance with the method, the performance of the heat exchanger is regulated whereby the gaseous state of aggregation of the refrigerant in the hot gas loop occurs at the inlet to compressor.

In one form of this aspect of the present invention, the refrigerant is CO₂.

In another form of this aspect of the present invention, the method includes regulating the flow rate of the coolant.

Pursuant to such additional expedients for precooling of the refrigerant (which can be provided separately or additionally), the lifetime of the components and the performance of the air conditioner are increased so that costs and primary energy may be saved.

### BRIEF DESCRIPTION OF THE DRAWINGS

FIG. 1 illustrates an embodiment of the present invention in the layout of an air conditioner of a vehicle;

FIG. 2 illustrates section A of FIG. 1 in detail according to a first practical example; and

FIG. 3 illustrates section A of FIG. 1 in detail according to a second practical example.

### DETAILED DESCRIPTION OF THE INVENTION

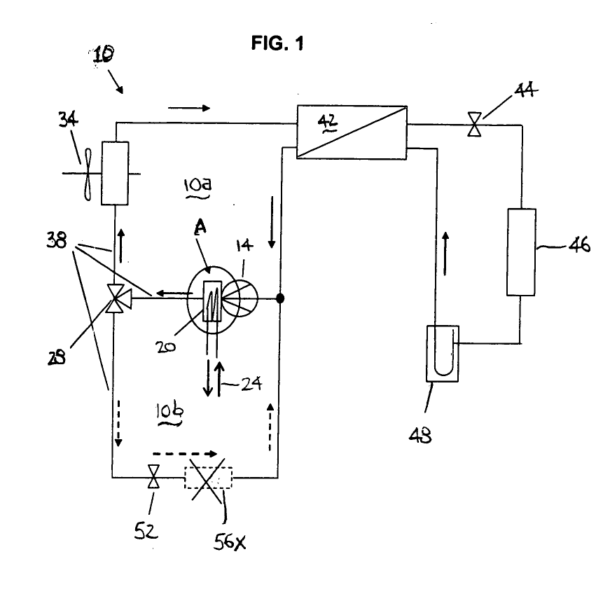

A refrigerant loop 10 having two different operating modes is depicted in the practical example of FIG. 1, and uses CO₂ as refrigerant. According to one (cooling) operating mode, the loop 10a is an air conditioner for cooling of the passenger compartment of a vehicle and, according to the second (heating) mode, the loop 10b is a hot gas cycle for heating of the coolant which can be used, for example, to heat the passenger compartment. The illustrated refrigerant loop 10 may be largely constructed from known components.

The refrigerant loop 10 as illustrated may advantageously operate as follows. The refrigerant is compressed in a compressor 14 to about 100 to 150 bar, in which case it is heated to about 170° C. While using the heat exchanger 20, the refrigerant is pre-cooled by the engine coolant 24. It is then fed by switching valve 28 either into the cooling loop 10a or the hot gas cycle 10b.

When the gas cooler 30 follows in the cooling loop 10a, the pre-cooled but still fairly hot refrigerant is cooled by the air stream of fan 34. The refrigerant passes through line 38 and, following the gas cooler 30, flows through an internal heat exchanger 42. After expansion through expansion valve 44, the refrigerant is cooled and is again heated somewhat in evaporator 46 which receives heat from the warm outside air flowing through it. The outside air is therefore cooled and is available to cool the passenger compartment. The refrigerant then flows through the collector 48, which separates the liquid fractions of the refrigerant and then again (but now on the other side) through the internal heat exchanger 42. There it cools the refrigerant on the high pressure side before expansion valve 44. The air conditioner loop is then closed and the refrigerant is compressed again in compressor 14.

If the switching valve 28 is set so that the air conditioner operates in the hot gas cycle 10b, the heat required to heat the passenger compartment is released directly at the compressor from heat exchanger 20 to the engine coolant 24. The refrigerant then flows through another expansion valve 52 and back to the compressor 14. In this way the heat exchanger 56x usually required in the prior art to provide the heated coolant for a heater (not shown) for heating of the passenger compartment can be omitted (as illustrated schematically by the crossed-out, dashed element in FIG. 1). Costs may therefore be reduced by elimination of the heat exchanger 56x, with only one heat exchanger 20 required in the entire system, which heat exchanger 20 is used both in the cooling mode 10a and in the heating mode 10b.

The hot gas cycle known from the prior art, contrasted to the hot gas cycle 10b of the present invention, is an automatically regulated cycle based on physics. Since a shift in the working range is obtained into the two-phase region with the present invention, in the hot gas cycle/heating mode 10b, control of the cooling power (e.g., by temperature-controlled regulation of the flow rate of the coolant 24 through the heat exchanger 20) is made necessary so that, after expansion of the cooled refrigerant at the expansion valve 52, no two-phase mixture is present. Without controlling the cooling power, an unstable loop would be produced in which liquid refrigerant occurs, which could adversely affect the compressor 14.

The lines 38 through which the refrigerant flows on the high pressure side of the air conditioner loop 10 have often been steel expansion tubes. However, by incorporating the heat exchanger 20 directly on a connection element 14a of compressor 14 as with the present invention, the refrigerant is cooled with the engine coolant 24 and such expensive steel expansion tubes can be omitted and more cost-effective tubes, seals and other accessories may advantageously be used instead.

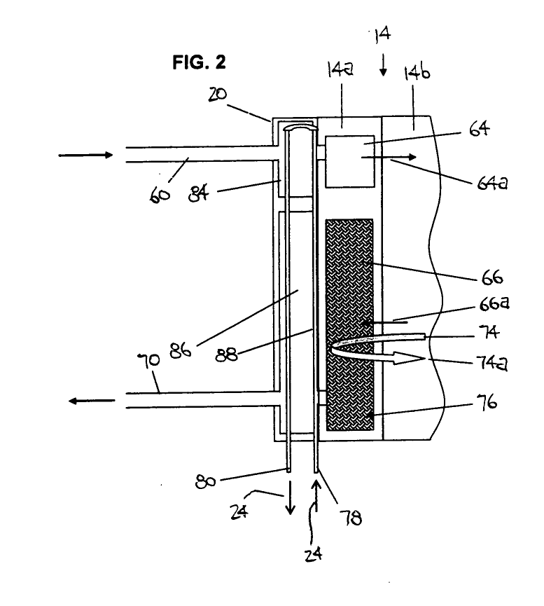

In accordance with the description herein, a heat exchanger combined with the compressor has become part of the compressor and, in any case, heat exchange between the coolant and the refrigerant occurs on the compressor. Such a heat exchanger 20 connected or combined with the compressor 14 according to the present invention is shown in FIG. 2, which is an enlarged view of section A of FIG. 1.

Specifically, as illustrated in FIG. 2, the refrigerant flows into the compressor 14 via an inlet connector 60. The compressor 14 has a cover or flange plate 14a or a similar connection element and a housing 14b, with an inlet chamber 64 and an outlet chamber 66 provided in the flange plate 14a. The inlet connector 60 discharges directly into inlet chamber 64 in the depicted practical example. From there the refrigerant passes through inlet opening 64a into the compression stage of compressor 14, where it is compressed. The refrigerant leaves the compressor 14 again through outlet opening 66a into the outlet chamber 66 and outlet connector 70, which is connected to line 38. On passing through the compressor 14, the refrigerant absorbs compressor oil 74 (which is required for the compressor 14 to function ideally). An internal compressor oil separator 76 may be integrated in the outlet chamber 66 so that the return 74a of compressor oil 74 separated from the refrigerant is permitted without significant expense.

The heat exchanger 20 is fastened to flange plate 14a with, for example, suitable fastening devices (not shown) so as to be in heat-conducting contact with the flange plate 14a of compressor 14. Engine coolant flows through the inlet 78 into the heat exchanger 20 so that the outflowing refrigerant is cooled. At the same time, this layout prevents a thermal short-circuit in the compressor, which means that the refrigerant flowing into the compressor 14 is not heated by the outflowing refrigerant. The coolant 24 leaves the heat exchanger 20 via outlet 80 and is fed back to the cooling loop of the engine. It should be understood, however, that different internal configurations of the heat exchanger 20 can be advantageously used within the scope of the present invention.

The flow channels 84, 86 for the refrigerant can be formed either by the two connectors 60 and 70, which are simply passed through by the heat exchanger 20 or, as shown in FIG. 2, the channels 84, 86 may consist of chambers. The refrigerant may also be advantageously passed through tube-like or plate-like flow channels 84, 86. Of course, the refrigerant on the high pressure side (channels 84) is prevented from reaching the low pressure side (channels 86) in the fashion of a short-circuit. Accordingly, the connector 60 of the low pressure side may be simply a flow channel 84 through the heat exchanger 20 with the high pressure side a tube-like or plate-like flow channel 86. The flow channels 84, 86 for the refrigerant are in heat-conducting contact with the flow channels 88 for the engine coolant 24, with the number of engine coolant flow channels 88 through the heat exchanger 20 being selected based on system heat exchange requirements.

As illustrated, two flow channels 88 are present through which the coolant 24 flows. These flow channels 88 can be designed to be either tubular or plate-like, or may be provided via holes in a solid plate. Moreover, heat-conducting contact between the flow channels 88 and flange plate 14a may be particularly effective.

An ordinary plate heat exchanger (such as described in patent application EP 1 400 772 A2, the disclosure of which is hereby incorporated by reference) or specially-configured plates providing the desired refrigerant cooling for the system may be advantageously used. Further, the shape of the heat exchanger 20 may be most advantageously configured based on the shape of compressor 14 and its flange plate 14a.

Further, it should be appreciated that the heat exchanger 20 may be equipped with or without a housing, but that the heat exchanger 20 may require only a few flow channels 84, 86, 88 for the different media. Still further, depending on the requirements of the particular system, turbulence-generating protrusions or inserts may also be provided to improve heat exchange of the different media in the different flow channels (not shown).

The possibility of connecting the inlet connector 60 without cooling laterally to flange plate 14a is not shown. It is important that a thermal short-circuit and a “pressure short-circuit” be avoided. Also, it should be appreciated that the heat exchanger 20 could, within the scope of the present invention, be integrated directly in the flange plate 14a (i.e., without requiring special fastening devices). It should further be appreciated that the number of flow channels 84, 86 for the refrigerant and flow channels 88 for the coolant should be advantageously selected according to overall system requirements to provide advantageous operation of the heat exchanger 20 in both the cooling mode (loop 10a) and the heating mode (loop 10b).

By incorporating the heat exchanger 20 directly in the compressor 14, the heat is advantageously released on the high pressure side of the loop. A greater temperature difference between the refrigerant and coolant is present there so that, in comparison with the prior art, a smaller heat exchanger can be provided. In addition, the additional equalization volume can be saved in this way, since operation of the air conditioner is very stable with the heat exchanger 20 according to the invention.

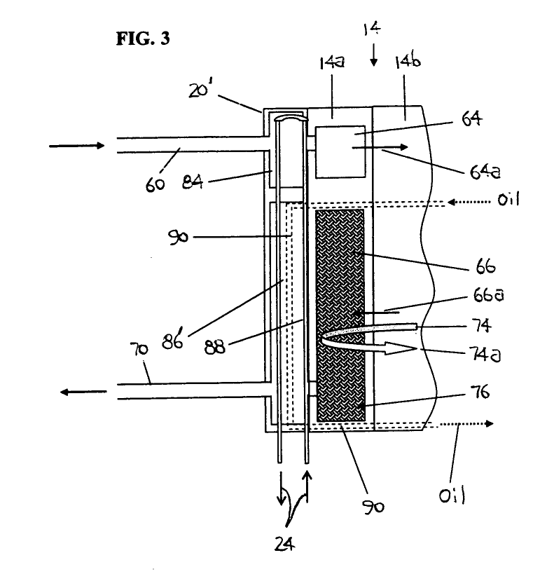

FIG. 3 illustrates another heat exchanger design which also may be advantageously used in accordance with the present invention. Identical components in FIG. 3 are given the same reference number as in FIG. 2, and similar but modified components are given the same number but with prime added (e.g., compressor 20′).

In the FIG. 3 design, the compressor oil 74 is actively cooled in the heat exchanger 20′ via flow channel 90. A heat exchanger 20′ suitable for three media may be advantageously used with this design. In the illustrated embodiment, the heat exchanger 20′ is a “housingless” heat exchanger, such as shown and described in EP 819 907 B1, the disclosure of which is hereby incorporated by reference. However, the heat exchanger 20′ as illustrated in FIG. 3 may only require a few flow channels 84, 86, 88, 90 for the different media. If necessary or desirable in a particular system, however, the heat exchanger 20′ may include a housing, and/or turbulence-generating protrusions or inserts may be used to increase the degree of heat exchange in the different flow channels of the media as is generally known in the art.

It should be appreciated that the compressor can include one or two pressure stages, depending on the system, including the layout of the air conditioner, with the heat exchanger according to the present invention provided at corresponding locations connected, for example directly at the connection element at the second pressure stage. However, it should be appreciated that two small heat exchangers could also be provided at each pressure stage in accordance with the present invention.

It should also be appreciated that the arrangement of a refrigerant/coolant heat exchanger combined with the compressor, or connected thereto by a heat-conducting connector, is advantageous in many ways.

For example, in automotive systems which have not had the heat exchanger 20 as discussed herein, the temperature of the flange plate 14a may be about 170° C. (i.e., about the temperature of the compressed, heated refrigerant in the compressor 14). At such high temperatures, the seals, the compressor oil 74, the aluminum housing 14b, 14a of the compressor 14 and other components are subject to fatigue relatively quickly. By cooling the flange plate 14a of compressor 14, the temperature of flange plate 14a is reduced and therefore the life of compressor 14 as well as its efficiency are significantly increased. Moreover, by direct or indirect cooling of the compressor oil 74, the entire compressor 14 is cooled and its performance increased.

Further, due to the heat-conducting connection of the heat exchanger to the compressor, it is also initially cooled. In this respect it is particularly advantageous if one of the channels of the heat exchanger that conveys the coolant is directly connected to a heat-conducting connection element of the compressor. By use of suitable connections on the compressor for the refrigerant and by cooling of the connection element (directly by means of the engine coolant), the efficiency of the entire air conditioner can be increased so that fuel consumption of the vehicle can also be reduced. Moreover, by use of the heat exchanger according to the invention, the frequently-present thermal short-circuit is prevented so that the refrigerant flowing into the compressor, if possible, does not come into thermal contact with outflowing compressed hot refrigerant.

Another attainable advantage of precooling of the refrigerant consists of the fact that more cost-effective connection lines can be provided in the refrigerant loop, so that the prior art expensive “high-temperature lines” on the high pressure side may be at least partially replaced (since the refrigerant is cooled by using the heat exchanger, preferably on the high pressure side).

It should further be appreciated that the embodiment having two operating modes (i.e., a heat pump mode or hot gas cycle and a cooling loop) may be provided with addition of merely a switching valve and at least one additional expansion valve arranged in the hot gas cycle. In the hot gas cycle, the heat exchanger may be used to furnish heated coolant to heat the passenger compartment of the vehicle and can therefore replace the heat exchanger otherwise common there.

It should still further be appreciated in the context of an advantageous operating method that the cooling power of the heat exchanger may be controlled (e.g., by controlling the flow rate of the coolant for the operating mode of the hot gas cycle), in order to prevent liquid refrigerant from flowing into the compressor (which could adversely affect the function of the compressor).

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. In a refrigerant loop of a vehicle air conditioner having at least one gas cooler/condenser, an evaporator and expansion valve, wherein a refrigerant is subjected to heat exchange with coolant of the vehicle engine in at least one location of the refrigerant loop, a compressor in heat exchange relationship with at least one refrigerant/coolant heat exchanger with at least one flow channel for the refrigerant and at least one flow channel for the coolant.

2. The compressor and heat exchanger of claim 1, wherein said refrigerant is CO₂.

3. The compressor and heat exchanger of claim 1, wherein said refrigerant flows in a selected direction and said heat exchanger, when viewed in the direction of refrigerant flow, is behind said compressor to cool the refrigerant on the high pressure side.

4. The compressor and heat exchanger of claim 1, further comprising:
at least one refrigerant inlet; and
at least one refrigerant outlet on the high pressure side;
wherein said refrigerant inlet and outlet are arranged in a single connection element.

5. The compressor and heat exchanger of claim 4, wherein said at least one refrigerant/coolant heat exchanger is directly adjacent to said connection element, and at least one flow channel for coolant is in heat-conducting contact with the connection element.

6. The compressor and heat exchanger of claim 1, further comprising
a separator integrated in said compressor, said separator adapted to remove compressor oil from the refrigerant; and
a return for the separated compressor oil.

7. The compressor and heat exchanger of claim 1, wherein said heat exchanger exchanges heat between three media.

8. The compressor and heat exchanger of claim 7, wherein said media are coolant, CO₂, and compressor oil.

9. The compressor and heat exchanger of claim 1, further comprising a second heat exchanger in heat-conducting connection with said compressor, said second heat exchanger tempering compressor oil by means of a coolant.

10. The compressor and heat exchanger of claim 1, wherein the shape of the heat exchanger is adapted to the shape of the compressor.

11. The compressor and heat exchanger of claim 1, wherein the refrigerant loop of the air conditioner consists essentially of a selected one of (a) only one cooling loop and (b) a cooling loop and a heating loop.

12. An operating method for an air conditioner with a refrigerant in a refrigerant loop having a cooling loop and a hot gas loop, said refrigerant being subjected to heat exchange with the coolant of the vehicle engine in a heat exchanger in at least one location of the refrigerant loop, comprising regulating the performance of the heat exchanger whereby the gaseous state of aggregation of the refrigerant in the hot gas loop occurs at the inlet to compressor.

13. The method of claim 12, wherein said refrigerant is CO₂.

14. The method of claim 12, further comprising regulating the flow rate of the coolant.
